(19) United States
(12) Patent Application Publication
(10) Pub. No.: US 2018/0375621 A1
(43) Pub. Date: Dec. 27, 2018

(54) DATA RETRANSMISSION

(71) Applicant: NOKIA SOLUTIONS AND NETWORKS OY, Espoo (FI)

(72) Inventors: Samuli Heikki Turtinen, Ii (FI); Timo Koskela, Oulu (FI); Vinh Van Phan, Oulu (FI)

(21) Appl. No.: 16/060,322

(22) PCT Filed: Dec. 14, 2015
(86) PCT No.: PCT/EP2015/079637

§ 371 Date: Jun. 7, 2018

(51) Int. Cl. H04L 1/18; H04L 1/00; H04B 7/06

(52) U.S. Cl. CPC H04L 1/1816; H04L 1/189; H04B 7/0697; H04L 1/1819; H04L 1/0003

(57) ABSTRACT

A technique is provided for controlling sending, by a user device to a network node in a wireless network via spatial multiplexing during a first transmission time interval, a first instance of a first protocol data unit via a first transport block and a first instance of a second protocol data unit via a second transport block, controlling receiving a first data indicator associated with the first transport block that indicates that the first transport block was not received by the network node, and controlling sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed. Other example spectrums may also be used, such as cmWave radio spectrum (3-30 GHz).

### SUMMARY

According to an example implementation, a method may include controlling sending, by a user device to a network node in a wireless network via spatial multiplexing during a first transmission time interval, a first instance of a first protocol data unit via a first transport block and a first instance of a second protocol data unit via a second transport block; controlling receiving a first data indicator associated with the first transport block that indicates that the first transport block was not received by the network node; controlling receiving a second data indicator associated with the second transport block that indicates that the second transport block was received by the network node; and controlling sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

According to an example implementation, an apparatus includes at least one processor and at least one memory including computer instructions, when executed by the at least one processor, cause the apparatus to: control sending, by a user device to a network node in a wireless network via spatial multiplexing during a first transmission time interval, a first instance of a first protocol data unit via a first transport block and a first instance of a second protocol data unit via a second transport block; control receiving a first data indicator associated with the first transport block that indicates that the first transport block was not received by the network node; control receiving a second data indicator associated with the second transport block that indicates that the second transport block was received by the network node; and control sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

According to an example implementation, an apparatus includes means for controlling sending, by a user device to a network node in a wireless network via spatial multiplexing during a first transmission time interval, a first instance of a first protocol data unit via a first transport block and a first instance of a second protocol data unit via a second transport block; means for controlling receiving a first data indicator associated with the first transport block that indicates that the first transport block was not received by the network node; means for controlling receiving a second data indicator associated with the second transport block that indicates that the second transport block was received by the network node; and means for controlling sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

According to an example implementation, a computer program product includes a computer-readable storage medium and storing executable code that, when executed by at least one data processing apparatus, is configured to cause the at least one data processing apparatus to perform a method including: control sending, by a user device to a network node in a wireless network via spatial multiplexing during a first transmission time interval, a first instance of a first protocol data unit via a first transport block and a first instance of a second protocol data unit via a second transport block; control receiving a first data indicator associated with the first transport block that indicates that the first transport block was not received by the network node; control receiving a second data indicator associated with the second transport block that indicates that the second transport block was received by the network node; and control sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

According to another example implementation, a method includes: controlling receiving, by a network node from a user device in a wireless network via spatial multiplexing during a first transmission time interval, at least a portion of a first instance of a first protocol data unit via a first transport block and a first instance of a second protocol data unit via a second transport block; decoding, unsuccessfully, the first instance of the first protocol data unit; decoding, successfully, the first instance of the second protocol data unit; controlling sending a first data indicator associated with the first transport block that indicates that the first transport block was not successfully decoded by the network node; controlling sending a second data indicator associated with the second transport block that indicates that the second transport block was successfully decoded by the network node; and controlling receiving, by the network node from the user device via spatial multiplexing during a second transmission time interval in response to sending the first data indicator, at least a portion of a second instance of the first protocol data unit via a third transport block and at least a portion of a third instance of the first protocol data unit via a fourth transport block.

According to an example implementation, an apparatus includes at least one processor and at least one memory including computer instructions, when executed by the at least one processor, cause the apparatus to: control receiving, by a network node from a user device in a wireless network via spatial multiplexing during a first transmission time interval, at least a portion of a first instance of a first protocol data unit via a first transport block and a first instance of a second protocol data unit via a second transport block; decode, unsuccessfully, the first instance of the first protocol data unit; decode, successfully, the first instance of the second protocol data unit; control sending a first data indicator associated with the first transport block that indicates that the first transport block was not successfully decoded by the network node; control sending a second data indicator associated with the second transport block that indicates that the second transport block was successfully decoded by the network node; and control receiving, by the network node from the user device via spatial multiplexing during a second transmission time interval in response to sending the first data indicator, at least a portion of a second instance of the first protocol data unit via a third transport block and at least a portion of a third instance of the first protocol data unit via a fourth transport block.

According to another example implementation, an apparatus includes: means for controlling receiving, by a network node from a user device in a wireless network via spatial multiplexing during a first transmission time interval, at least a portion of a first instance of a first protocol data unit via a first transport block and a first instance of a second protocol data unit via a second transport block; means for decoding, unsuccessfully, the first instance of the first protocol data unit; means for decoding, successfully, the first instance of the second protocol data unit; means for controlling sending a first data indicator associated with the first transport block that indicates that the first transport block was not successfully decoded by the network node; means for controlling sending a second data indicator associated with the second transport block that indicates that the second transport block was successfully decoded by the network node; and means for controlling receiving, by the network node from the user device via spatial multiplexing during a second transmission time interval in response to sending the first data indicator, at least a portion of a second instance of the first protocol data unit via a third transport block and at least a portion of a third instance of the first protocol data unit via a fourth transport block.

A computer program product includes a computer-readable storage medium and storing executable code that, when executed by at least one data processing apparatus, is configured to cause the at least one data processing apparatus to perform a method including: controlling receiving, by a network node from a user device in a wireless network via spatial multiplexing during a first transmission time interval, at least a portion of a first instance of a first protocol data unit via a first transport block and a first instance of a second protocol data unit via a second transport block; decoding, unsuccessfully, the first instance of the first protocol data unit; decoding, successfully, the first instance of the second protocol data unit; controlling sending a first data indicator associated with the first transport block that indicates that the first transport block was not successfully decoded by the network node; controlling sending a second data indicator associated with the second transport block that indicates that the second transport block was successfully decoded by the network node; and controlling receiving, by the network node from the user device via spatial multiplexing during a second transmission time interval in response to sending the first data indicator, at least a portion of a second instance of the first protocol data unit via a third transport block and at least a portion of a third instance of the first protocol data unit via a fourth transport block.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram of a wireless transceiver according to an example implementation.

FIG. 3 is a diagram illustrating operation of a wireless system according to an example implementation.

FIG. 4 is a diagram illustrating operation of a wireless system according to another example implementation.

FIG. 5 is a diagram illustrating a MAC PDU format according to yet an example implementation.

FIG. 6 is a flow chart illustrating operation of a user device according to an example implementation.

FIG. 7 is a flow chart illustrating operation of a network node according to an example implementation.

FIG. 8 is a block diagram of a wireless station (e.g., base station/access point or mobile station/user device) according to an example implementation.

### DETAILED DESCRIPTION

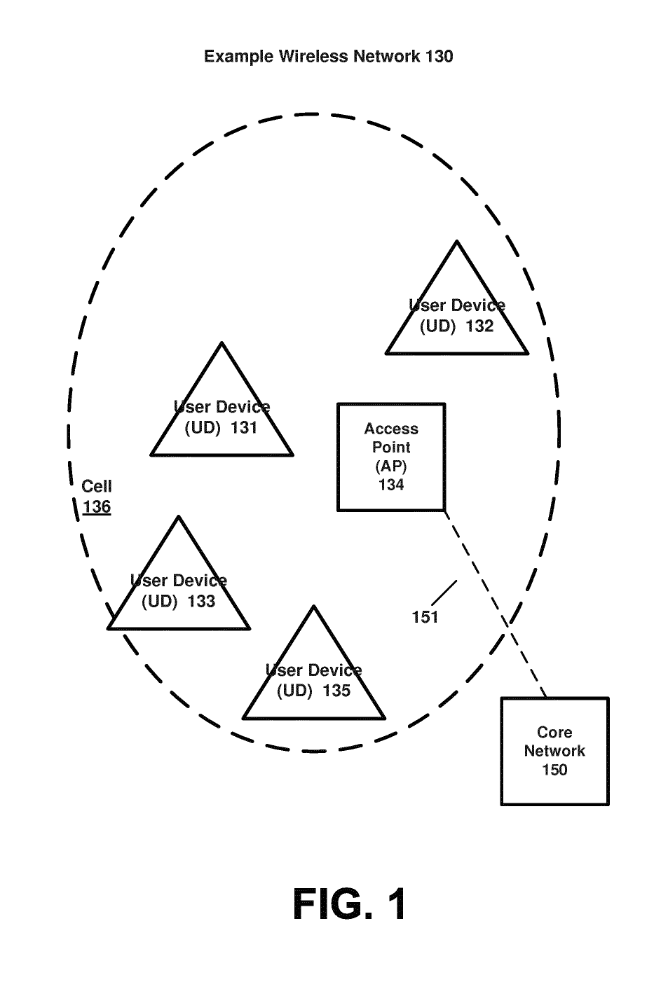

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with an access point (AP), which may also be referred to as a base station (BS), an enhanced Node B (eNB) or a network node. At least part of the functionalities of an access point (AP), base station (BS) or (e)Node B (eNB) may be also be carried out by any node, server or host which may be operably coupled to a transceiver, such as a remote radio head. AP 134 provides wireless coverage within a cell 136, including to user devices 131, 132, 133 and 135. Although only four user devices are shown as being connected or attached to AP 134, any number of user devices may be provided. AP 134 is also connected to a core network 150 via a 51 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, or any other wireless network. LTE, 5G, cmWave and mmWave band networks are provided only as illustrative examples, and the various example implementations may be applied to any wireless technology/wireless network.

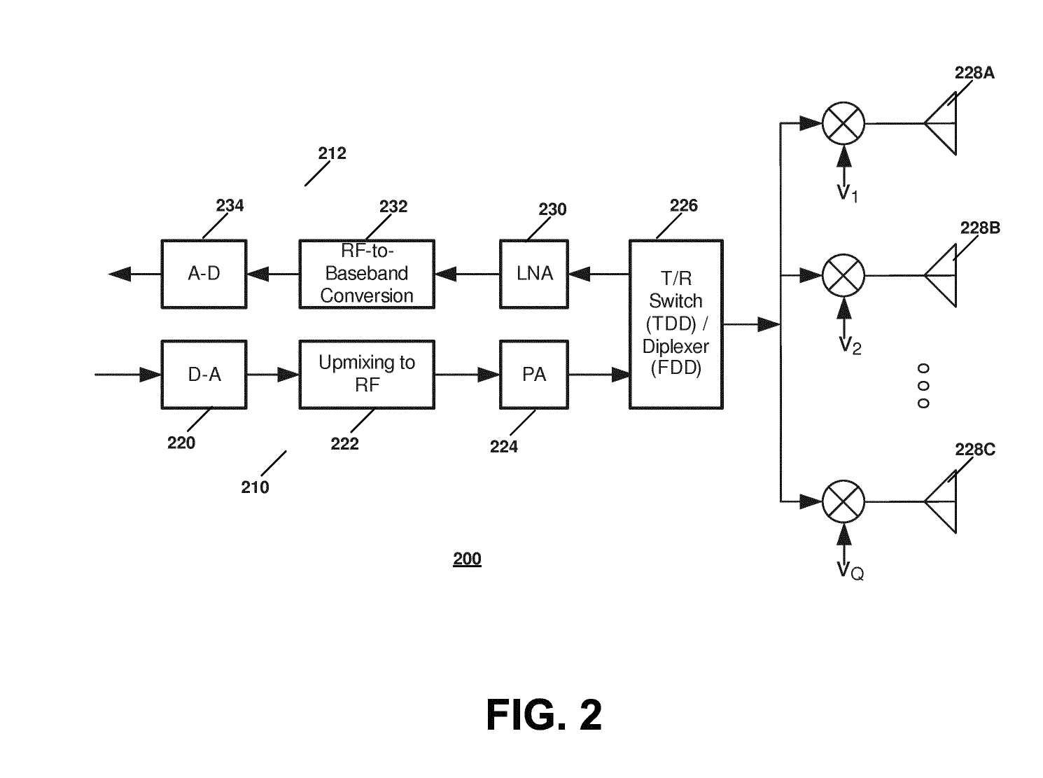

FIG. 2 is a diagram of a wireless transceiver according to an example implementation. Wireless transceiver 200 may be used, for example, at a base station (BS), e.g., Access Point (AP) or eNB, or other wireless device. Wireless transceiver 200 may include a transmit path 210 and a receive path 212.

In transmit path 210, a digital-to-analog converter (D-A) 220 may receive a digital signal from one or more applications and convert the digital signal to an analog signal. Upmixing block 222 may up-convert the analog signal to an RF (e.g., radio frequency) signal. Power amplifier (PA) 224 then amplifies the up-converted signal. According to an example implementation, the power amplifier may be integrated to or with an antenna element. The amplified signal is then passed through a transmit/receive (T/R) switch (or Diplexer 226 for frequency division duplexing, to change frequencies for transmitting). The signal output from T/R switch 226 is then output to one or more antennas in an array of antennas 228, such as to antenna 228A, 228B and/or 228C. Prior to being transmitted by one or more of the antennas in the array of antennas 228, a set of beam weights V1, V2, . . . or VQ is mixed with the signal to apply a gain and phase to the signal for transmission. For example, a gain and phase, V1, V2, . . . or VQ, may be applied to the signal output from the T/R switch 226 to scale the signal transmitted by each antenna (e.g., the signal is multiplied by V1 before being transmitted by antenna 1 228A, the signal is multiplied by V2 before being transmitted by antenna 2 228B, and so on), where the phase may be used to steer or point a beam transmitted by the overall antenna array, e.g., for directional beam steering. Thus, the beam weights V1, V2, . . . or VQ (e.g., each beam weight including a gain and/or phase) may be a set of transmit beamforming beam weights when applied at or during transmission of a signal to transmit the signal on a specific beam, and may be a set of receive beamforming beam weights when applied to receive a signal on a specific beam.

In receive path 212 of wireless transceiver 200, a signal is received via an array of antennas 228, and is input to T/R switch 226, and then to low noise amplifier (LNA) 230 to amplify the received signal. According to an example implementation, the LNA may be co-located with an antenna element. The amplified signal output by LNA 230 is then input to a RF-to-baseband conversion block 232 where the amplified RF signal is down-converted to baseband. An analog-to-digital (A-D) converter 234 then converts the analog baseband signal output by conversion block 232 to a digital signal for processing by one or more upper layers/application layers.

Various example implementations may relate, for example, to 5G radio access systems (or other systems) with support for Massive MIMO (multiple input, multiple output) and optimized for operating in high carrier frequencies such as cmWave frequencies (e.g. from 3 GHz onwards) or mmWave frequencies, as examples, according to an illustrative example implementation. Those illustrative systems are typically characterized by the need for high antenna gain to compensate for increased pathloss and by the need for high capacity and high spectral efficiency to respond to ever increasing wireless traffic. According to an example implementation, the increased attenuation at higher carrier frequencies may, for example, be compensated by introducing massive (multi-element) antenna arrays and correspondingly antenna gain via beamforming at the access point (AP)/base station (BS) and/or user device. The spectral efficiency may typically improve with the number spatial streams the system can support and thus with the number of antenna ports at the AP/BS. According to an example implementation, spatial multiplexing may include a transmission technique in MIMO wireless communication to transmit independent and separately encoded data signals, so-called streams, from each of the multiple transmit antennas.

According to an example implementation, some form of forward error correction (FEC) may be used to improve communication, whereby redundancy is introduced by adding parity bits to the information bits prior to transmission. Automatic repeat request (ARQ) may also be used where a cyclic redundancy check (CRC) may be used to detect if the received packet has any errors or not. If no errors are detected, the receiver sends an acknowledgment (ACK) while if an error is detected the receiver sends a negative acknowledgment (NAK). In addition, some wireless communication devices may employ hybrid ARQ (HARQ) which may combine aspects of FEC and ARQ, e.g., where multiple HARQ processes operating in parallel may be used to transmit transport blocks (TBs) for each HARQ process while waiting for an ACK for another HARQ process. The HARQ operation discards erroneously received packets and will request retransmission of such packets by sending a NAK to the transmitter.

Also, soft combining, Chase combining or incremental redundancy (or other data combining technique) may be used where a receiver may store an erroneously received protocol data unit (PDU). The receiver may combine this stored protocol data unit with one or more retransmissions of the protocol data unit, so long as the protocol data units being combined represent the same information bits (e.g., parity bits in each combined protocol data unit sent via a different transport block may be different). Also, with incremental redundancy, a transmitter may transmit different redundancy versions (RVs) of a packet/protocol data unit that may include the same information bits but different parity bits (or a different number of parity bits). In incremental redundancy, each redundancy version contains different information: different set of coded bits generated from the original data bits. Each different set is referred as a redundancy version (RV), such as RV0, RV1, RV2, RV3. In Chase combining the transmitted and retransmitted has the same information: data and the parity bits are the same. So, for example, in Chase combining, redundancy version 0 (RV0) may be transmitted in the original transmission and subsequent retransmissions of the data.

Each different RV may be sent via a different transport block (TB). The different redundancy versions of a protocol data unit may be referred to as redundancy version 0 (RV0), RV1, RV2, RV3, etc. For example, an initial transmission of a protocol data unit or transport block (TB) may be transmitted as redundancy version 0 (RV0), while a subsequent retransmission of the protocol data unit or the TB may be transmitted as a different RV, e.g., RV1, RV2, RV3, according to an example implementation, where each redundancy version contains a different set of coded bits. A transport block (TB) may include an encoded protocol data unit, including both information bits and parity bits. For example, a MAC PDU (media access control protocol data unit) may be encoded (including both information bits and parity bits) as a transport block (TB), and may be sent as RV0 of the PDU. A different redundancy version (e.g., RV1, RV2, RV3) of the PDU may be sent as a retransmission. The transport block or the PDU are not initially coded, but are then appended with a CRC (cyclic redundancy check) before the coding/additions of parity bits. Thus, after this operation, the transport block is a coded transport block.

According to an example implementation, an uplink transmission from a user device to an AP may be triggered by the user device receiving an uplink grant on a downlink control channel. In an example implementation, a grant may include, for example, either a grant for a new transmission or a grant for a retransmission. A data indicator, such as a new data indicator (NDI), which may be included in scheduling information sent to the user device, may indicate whether the AP is requesting a new transmission (new data) or a retransmission of previously sent data. For example, the AP may toggle (change states) of the NDI to request the user device to transmit new data (e.g., a new PDU), whereas the AP may keep the NDI in the same state (not toggle the NDI) to request the user device to retransmit the PDU. The AP may combine (e.g., using Chase combining or incremental redundancy or other data combining technique) the originally transmitted PDU (e.g., stored in a HARQ buffer at the AP) with the retransmitted PDU to improve the likelihood of being able to decode the combined PDU. For example, the originally transmitted PDU and the retransmitted PDU may be different redundancy versions of the PDU (e.g., different set of coded bits generated from the same information bits).

According to an example implementation, a media access control (MAC) layer (or MAC entities at the user device and AP) may transmit data over a wireless/radio interface in the form of variable-size transport blocks (TBs). A MAC PDU (e.g., including a MAC header and a payload) may be encoded (to include information bits and parity bits) and then transmitted via a TB. The encoded PDU may be transmitted via a TB as one of a plurality of redundancy versions (RVs) of the PDU, where a different set of coded bits may be provided in each of the RVs, for example.

In the absence of spatial multiplexing (e.g., only one spatial layer), only one TB may be transmitted over a radio interface to or from a user device during one transmission time interval (TTI), which may be the time period to transmit a subframe. However, when MIMO or spatial multiplexing is performed (multiple spatial layers), multiple TBs may be transmitted per TTI over a radio interface. For example, with two antennas (or two spatial layers), two TBs may be transmitted during a TTI, e.g., one TB per spatial layer (or, as another example, one TB transmitted by each antenna, per TTI). Similarly, four TBs may be transmitted per TTI with four antennas/four spatial layers, and eight TBs may be transmitted per TTI with eight antennas/eight spatial layers, etc. Thus, according to an illustrative example implementation, one TB may be transmitted over a radio/wireless interface per spatial layer (or per antenna) during one TTI. Also, a wireless system may use (transmit/receive during one TTI) fewer TBs than spatial layers.

According to an example implementation, when two TBs are transmitted per TTI, the AP may attempt to decode the PDU provided in each TB, and then provide a NDI (or data indicator) for each TB, e.g., either to request a new transmission (e.g., where the AP was able to decode the corresponding PDU) or to request a retransmission (e.g., where the AP was unable to successfully decode the PDU in a corresponding TB).

In one illustrative example, a wireless system may perform spatial multiplexing and allow two TBs to be transmitted during each TTI. In such an example system, a user device may transmit a first TB and a second TB during a first TTI. In an example implementation, only one (e.g., the second TB) of the two TBs transmitted during the first TTI is received and successfully decoded by the AP, while the first TB is not successfully decoded by the AP. The AP may provide an NDI (data indicator) signal associated with each of the first and second TBs. Thus, in this illustrative example, the NDI associated with the decoded second TB may be toggled (to request a new TB, and thus indicating receipt/decoding of the second TB), while the AP may not toggle the NDI associated with the erroneously received (not decoded) first TB (thus, requesting retransmission of the first TB).

According to an example implementation, various techniques may be used to improve a likelihood that an AP may be able to decode a retransmitted PDU (or portion thereof) in a MIMO wireless network or a wireless network in which spatial multiplexing is performed. For example, multiple (e.g., two or more) TBs during a second TTI may be used to transmit multiple (e.g., two or more) instances (or at least portions thereof) of a failed PDU, e.g., to improve a likelihood the AP will be able to decode the PDU. While the various examples and implementations described herein may be described and illustrated for wireless systems that employ two spatial layers/two TBs per TTI, the techniques and example implementations described herein may be applied to wireless systems in which more than two TBs may be transmitted per TTI.

As described herein, and/or as used or described with reference to one or more of the example implementations illustrated in any of FIGS. 1-8, the phrase instance of a protocol data unit (instance of a PDU) may include PDUs that have at least a common (or same) PDU payload (or portion thereof, such as, for example, one or more same/common service data units/SDUs within the PDU payload), and/or may be a same or different redundancy version of the PDU. For example, multiple instances of a PDU may include a same MAC payload (or a portion thereof) that is the same for the multiple instances of the PDU, and such PDUs may include a same MAC header or a different MAC header and/or a different value for one or more field(s) within a MAC header. As noted, in one illustrative example implementation, multiple instances of a PDU may be same or different redundancy versions (e.g., RV0, RV1, RV2, or RV 3) of the PDU (e.g., multiple instances of a PDU may include different parity bits, and/or a different set of coded bits). Multiple instances of a PDU may include a new (original) transmission of a PDU and/or a retransmission of the PDU.

According to an example implementation, the term redundancy version may use or may include the use of turbo coding, convolutional coding, LDPC (Low Density Parity-Check) or other channel coding techniques, for channel coding. For example, in turbo coding and LDPC coding, the encoder may create one or more sets of coded bits (redundancy versions) whereas convolutional coding may produce one set of coded bits which may be considered as RV0 (for example). Thus, different types of coding may be used to generate one or more redundancy versions or sets of coded bits. Also, different types of data combining, such as Chase combining, soft combining, or incremental redundancy (as examples), may be used to combine different data sets or redundancy versions.

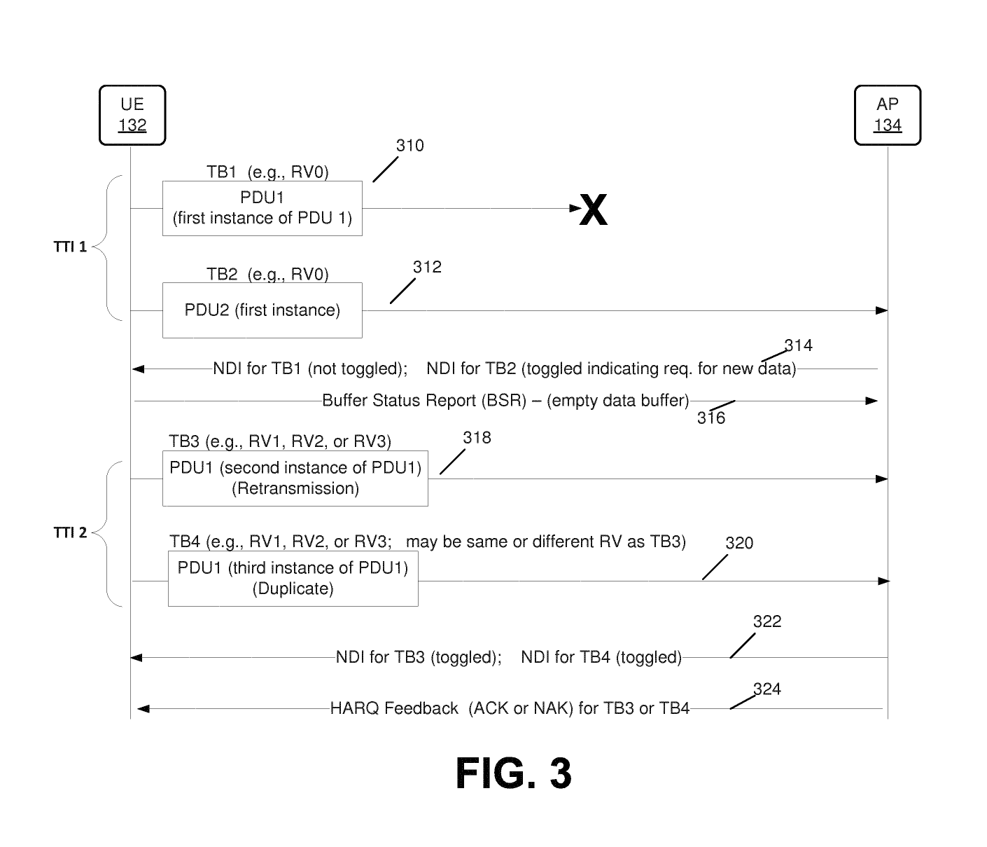

FIG. 3 is a diagram illustrating operation of a wireless system according to an example implementation. According to an example implementation of the operation shown in FIG. 3, multiple instances of a same PDU may be same or different redundancy versions of the PDU, for example. In the illustrative example shown in FIG. 3, spatial multiplexing is provided, e.g., with two spatial layers, such that two TBs may be transmitted over a radio/wireless interface during each TTI. While the example shown in FIG. 3 is illustrated for two spatial layers/two TBs per TTI, the techniques described may be applied to wireless systems in which more than two TBs may be transmitted per TTI.

As shown in FIG. 3, a UE (or user device) 132 may be in communication with AP 134. During transmission time interval (TTI) 1 (TTI1), UE 132 transmits a first instance of PDU1 via TB1 (at 310) and a first instance of PDU2 via TB2 (at 312). For example, the first instance of PDU1 may be RV0 of PDU1, and the first instance of PDU2 may be RV0 of PDU2. These are merely examples.

As shown in the example of FIG. 3, the first instance of PDU1 is not successfully decoded by AP 134 (as indicated by the X), thus, PDU1 is a failed PDU. While the first instance of PDU2 is received and successfully decoded by AP 134. Thus, at 314, AP 134 provides NDI (data indicator) signals to the UE 132, including an NDI for TB1 that is not toggled to indicate that TB1/first instance of PDU1 was not decoded (requesting a retransmission of PDU1), and including an NDI for TB2 that is toggled to indicate that TB2/first instance of PDU2 was received and decoded and to request transmission of new data. Also, according to an example implementation, UE 132 may provide, or may have earlier provided, a buffer status report (BSR) (at 316) to AP 134 indicating that the UE 132 has no (new) data to transmit (empty data buffer), for example. For example, the BSR may be sent with transmission of TB1 and/or TB2, for example, or may be sent separately, as some examples.

According to an example implementation, when one of the two (less than all) of the transmitted TBs in TTI1 are not successfully decoded by the AP 134, the UE 132 may send two additional instances of the failed PDU (PDU1) during TTI2 if the UE 132 has no new data to transmit (e.g., empty data buffer). Thus, in the example shown in FIG. 3, the combination of AP 134 not toggling the NDI for TB1/PDU1 (requesting a retransmission of the failed PDU/PDU1), and the empty BSR (at 316) from UE 132 (indicating no data in the buffer for transmission), these signals indicate that the UE 132 will use both of the (or multiple) TBs of a next TTI (TTI2) to send two (or multiple) additional instances of the failed PDU (PDU1).

Alternatively, rather than relying on a presence or communication of an empty BSR sent from UE 132 to AP 134 (to indicate that a duplicate PDU will be sent via the TB4), the UE 132 or the AP 134 may send a control signal/control signaling to the other party indicating that a duplicate PDU will be provided via TB4 (rather than transmission of new data in TB4). Thus, the empty BSR or other control signaling, in combination with a non-toggled NDI (indicating a request for retransmission) for one of the TBs for TTI1 (e.g., for PDU1) may indicate that the data sent via TB4 is a duplicate of data sent via TB3 in TTI2 (that is, indicating that the data/payload (or portion thereof) provided via TB4 will include the same data/payload (or portion thereof) as in TB3).

Therefore, as shown in FIG. 3, during TTI2, UE 132 may (at 318) transmit/send a second instance of PDU1, which may be the requested retransmission of PDU1 (retransmission requested for PDU1 based on NDI for TB1 not being toggled) via TB3, and transmit/send (at 320) a third instance of PDU1 via TB4. For example, as a retransmission of PDU1, the second instance of PDU1 sent via TB3 may be a redundancy version (RV) that is different from the RV of the first instance of the PDU1. Thus, for example, if the first instance of the PDU1 was RV0, then the second instance of PDU1 may be RV1, RV2, RV3, etc. The third instance of the PDU1 sent (at 320) via TB4 may be the same or different RV as the second instance of PDU1/TB3. Also, according to an example implementation, the data/payload may be the same for each of the first instance, second instance, and third instance of PDU1. In addition, according to an example implementation, the second instance of PDU1 (sent via TB3) and the third instance of PDU1 (sent via TB4) may be the same RV or different RVs as the first instance of PDU1 (sent via TB1). Thus, for example, the first instance, second instance, and the third instance of the PDU1 may each be the same RV. Alternatively, the first instance, second instance, and third instance may each be a different RV of PDU1, e.g., the first instance may be RV0 of PDU1, the second instance may be RV1 of PDU1, and the third instance may be RV2 of PDU1, in an illustrative example. These are merely some illustrative examples.

Also, in this example, based on the empty BSR (indicating UE 132 has no new data to send to AP 134) and the NDI for TB1 that was not toggled (thus, AP 134 requesting a retransmission of PDU1), it is understood between the UE 132 and AP 134 that the TB4 (including the third instance of PDU1) contains a duplicate of the second instance of the PDU1 provided via TB3. Thus, in this example, the term duplicate for TB4 means that the data (or portion thereof) provided via TB4 is a duplicate of the data (or portion thereof) provided via TB3 (the other TB sent via the same TTI), and is not new data. Therefore, in such a case, rather than not use (or omit transmitting any data during) the available TB4 via TTI2, this TB4 may be used to send an additional instance (e.g., third instance, at 320) of the failed PDU (PDU1), e.g., to improve the likelihood that AP 134 may be able to decode PDU1.

On the other hand, although not shown in FIG. 3, according to an example implementation, if the BSR from UE 132 had indicated that the UE 132 had new data for transmission, and/or if the NDI for TB1 was toggled (indicating a request to send new data), then UE 132 may typically send new data via TB4 (which would typically be different (not duplicate data) from the PDU sent via TB3).

The AP 134 may receive the second instance and third instance of PDU1, and may then combine (e.g., via soft combining, incremental redundancy, or other data combining technique)) the multiple instances (e.g., first instance at 310, second instance at 318 and/or third instance at 320) of PDU1 to obtain a combined PDU1, and thus, make it more likely that AP 134 will be able to decode PDU1.

At 322, AP 134 may send NDI (data indicator) signals for TB3 and TB4, including, for example, a toggled NDI for both TB3 and TB4, e.g., indicating a request for new data for both TBs of a next TTI (and thus, indicating that PDUs for TB3 and TB4 were received and decoded), according to an illustrative example. Although, according to an alternative example implementation, NDIs for both TB3 and TB4 may be toggled (indicating a request for transmission of new data) even if only one of the PDUs sent via TB3 or TB4 was successfully decoded (or PDU1 was decoded using a data combination technique), e.g., because the data of TB4 is a duplicate of the data of TB3, for example. In an example implementation, the data indicator/NDI signals may be sent with an uplink grant to UE 132.

Also, at 324, according to an example implementation, AP 134 may provide HARQ feedback (e.g., ACK/acknowledgement that acknowledges receipt of a TB, or NAK/negative acknowledgement that indicates a TB was not received) for either TB3 or TB4, but not (necessarily) for both TB3 and TB4. This is because, in this illustrative example, the TB4 includes a duplicate of the data (at least the payload or portion of the payload) of the data provided via TB3. Thus, if the data was successfully communicated via either TB3 or TB4 (or both, or via a combination of the multiple instances of PDU1), then an ACK may be sent for one of the TBs, (e.g., via TB3) but it would be unnecessary (and would create unnecessary overhead) to send an ACK for both TB3 and TB4 in this case (because TB3 and TB4 provide instances of the same PDU payload).

The example implementation illustrated in FIG. 3 may be applied to systems that provide more than two spatial layers (or systems that transmit more than two TBs per TTI), such as for four spatial layers (e.g., four TBs per TTI), eight spatial layers (e.g., eight TBs per TTI), etc. For example, in the case for four TBs per TTI, TBs 1-4 may be sent during TTI1, and TBs 5-8 may be sent via TTI2. For example, if TB1, including a first instance of PDU1 (sent during TTI1) failed/was not decoded at AP 134, then the NDI for such failed TB (TB1) would not be toggled (indicating a request for retransmission of PDU1). For example, based on the empty BSR (or other control signaling) and the failed PDU1/TB1 (indicated by no toggle on NDI for TB1), an instance (e.g., second instance) of PDU1 may be retransmitted via one or more other TBs during TTI2, e.g., a second instance of PDU1 may be sent via TBS, a third instance of PDU1 (considered a duplicate of data in TB5) may be sent via TB6 or TB7, etc. Also, UE 132 may notify AP 134, or AP 134 may notify UE 132, of which TBs (e.g., TB6 or TB7) during TTI2 will (or should or may) include a duplicate data (not new/non-duplicate data). Thus, according to this illustrative example, a second instance (as a retransmission) of PDU1 may be transmitted via TB5 (according to this illustrative example), and also a third (or more) instances of PDU1 may be provided (as duplicate data) and sent via one or more other TBs (e.g., TB6, TB7, and/or TB8) of TTI2.

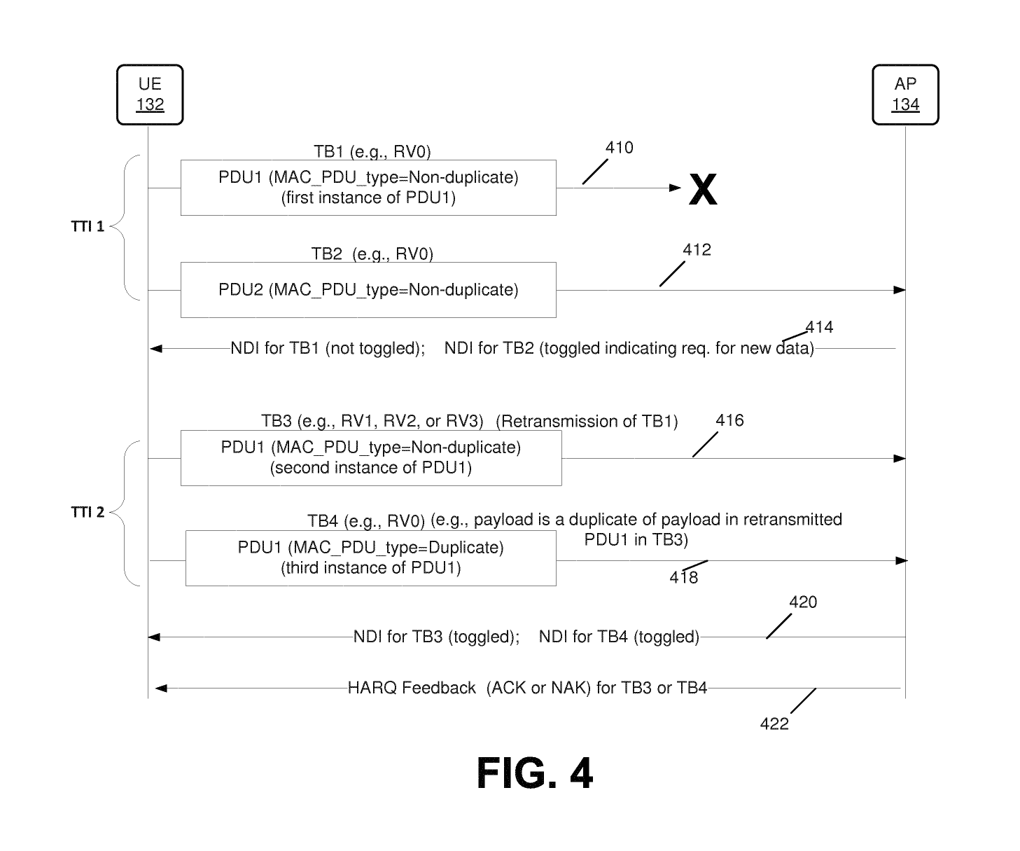

FIG. 4 is a diagram illustrating operation of a wireless system according to another example implementation. The implementation of FIG. 4 is similar to the implementation shown in FIG. 3, except for the differences noted below. According to an example implementation of the operation shown in FIG. 4, multiple instances of a same PDU payload may be sent via different TBs. According to the example implementation shown in FIG. 4, rather than relying upon an empty BSR report (as in FIG. 3) to indicate that duplicate data will (or may) be sent via one or more of the TBs, the implementation of FIG. 4 uses a MAC_PDU_type field within a MAC header of each PDU to indicate whether the PDU is a non-duplicate data or a duplicate data. When the MAC_PDU_type field is set to non-duplicate, this means that the MAC PDU includes data that is not a duplicate of other data/PDU sent during the same TTI. Whereas, when the MAC_PDU_type field is set to duplicate, this means that the MAC PDU includes duplicate data/payload (or at least a portion thereof) that is the same as (or a duplicate of) data/payload (or portion thereof) of another PDU sent via a different TB during the same TTI.

Referring to FIG. 4, during TTI1, UE 132 sends (at 410) a first instance of PDU1 via TB1, and sends (at 412) a first instance of PDU2 via TB2. For example, the first instance of PDU1 may be redundancy version RV0 of PDU1, and the first instance of PDU2 may be RV0 of PDU2. In this illustrative example, both the first instance of PDU1 and the first instance of PDU2 may include a MAC_PDU_type field set to non-duplicate.

According to an example implementation, the first instance of PDU1 (at 410) is not successfully decoded by AP 134 (as indicated by the X), thus, PDU1 is a failed PDU. While the first instance of PDU2 (at 412) is received and successfully decoded by AP 134. Thus, at 414, AP 134 provides NDI (data indicator) signals to the UE 132, including an NDI for TB1 that is not toggled to indicate that TB1/first instance of PDU1 was not successfully decoded (requesting a retransmission of PDU1), and including an NDI for TB2 that is toggled to indicate that TB2/first instance of PDU2 was received and successfully decoded and to request transmission of new data. For example, the NDI signals may be provided via TB1 or TB2, or as a separate signal, in illustrative examples.

Also, according to an example implementation, while a UE 132 may provide a buffer status report (BSR) to AP 134, e.g., which may indicate that the UE 132 has no (new) data to transmit (empty data buffer), the MAC_PDU_type field included in each MAC PDU indicates whether or not a PDU includes duplicate data or not. Thus, while UE 132 may send a BSR to AP 134, a BSR report is not necessarily used in this example implementation to indicate whether or not a PDU will or may include duplicate data (rather the MAC_PDU_type field may provide this duplicate/non-duplicate information).

During TTI2, UE 132 sends (at 416) to AP 134 a second instance of PDU1 via TB3, with MAC_PDU_type field set to non-duplicate. The second instance of PDU1 may be a retransmission of PDU1, and may be sent as, for example, a redundancy version such as RV1, RV2, RV3 of PDU1. During TTI2, UE 132 also sends (at 418) to AP 134 a third instance of PDU1 via TB4, with MAC_PDU_type field set to duplicate (e.g., indicating that the third instance of PDU1 sent via TB4 includes duplicate (or same) data/payload as the second instance of PDU1 sent via TB3). In one example implementation, a TB size may be used (or require ed in some cases) to send a duplicate data that is at least as large as a size of the original TB.

The third instance of PDU1 includes a field (MAC_PDU_type field set to duplicate) in the MAC header with a different value than the first and second instances of PDU1. Thus, while the first and second instances of PDU1 may be different redundancy versions of the same PDU, the third instance of PDU1 will be separately encoded (because the information bits of the third instance of PDU1 have changed), e.g., as RV0, prior to being transmitted via TB4.

AP 134 may receive the second and third instances of PDU1, and may use data combining to decode PDU1 (or at least the payload for PDU1), e.g., based on the first instance of PDU1, the second instance of PDU1. According to this illustrative example, the third instance of PDU1, for example, may not typically be used for data combining with the second and third instances of PDU1 because the third instance was separately encoded as compared to the first and second instances of PDU1.

At 420, AP 134 may send NDI signals, including toggling the NDI signals for one or both TB3 and TB4, for example. At 422, AP 134 may send HARQ feedback for TB3 and/or TB4 (e.g., by sending an ACK for TB3 and/or TB4). However, it may be necessary to send HARQ feedback (ACK/NAK) only for one of TB3 and TB4, e.g., because TB3 and TB4 include the same data/payload. Similarly, it may be necessary to provide NDI signal only for one of the TB3 and TB4, or it may be necessary to toggle the NDI only for one of TB3 and TB4 (e.g., if NDI is toggled for either TB3 or TB4, then this indicate there is no need to retransmit this data).

In a manner that is similar to what is described with respect to FIG. 3, the example implementation(s) describe in FIG. 4 may be applied to wireless networks that may send more than two TBs per TTI. That is, in the case of four or more TBs per III, UE 132 may send two or more instances of PDU1 during TTI2 (including a retransmission PDU and one or more duplicate PDUs). For example, TBs 1-4 may be sent during TTI1, and TBs 5-8 may be sent during TTI2. For example, UE 132 may send: a first instance of PDU1 (failed) during TTI1 (MAC_PDU_type field set to non-duplicate) via TB1, and may send, during TTI2, a second instance of PDU1 (MAC_PDU_type field set to non-duplicate) via TBS, a third instance of PDU1 (MAC_PDU_type field set to duplicate) via TB6, and a fourth instance of PDU1 (MAC_PDU_type field set to duplicate) via TB7 or TB8. Thus, multiple (two or more) duplicate PDUs (e.g., having a MAC_PDU_type set to duplicate) may be sent during TTI2, in addition to a retransmission (e.g., MAC_PDU_type field set to non-duplicate) of the PDU1. The network, AP 134 and/or UE 132 may indicate which TBs will (or may) be used to send the duplicate PDUs (rather than sending new data).

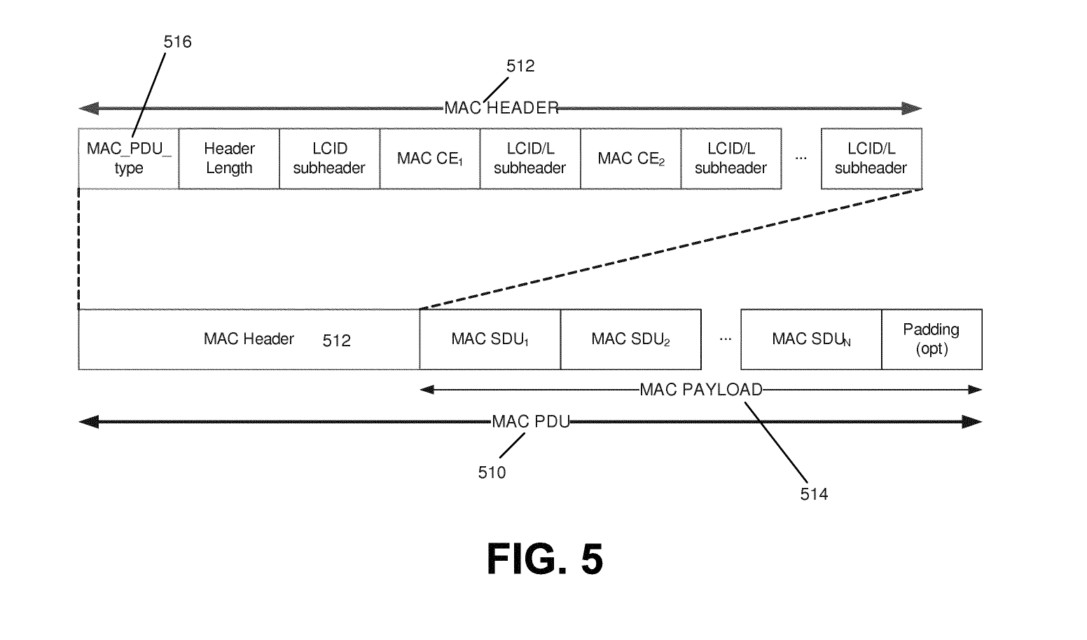

FIG. 5 is a diagram illustrating a MAC PDU format according to yet an example implementation. In this illustrative example, MAC PDU 510 includes a MAC header 512 and a MAC payload 514. MAC payload 514 may include one or more MAC service data units (MAC SDUs), such as MAC SDU1, SDU2, . . . SDUN). MAC header 512 may include a number of fields, such as a MAC_PDU_type field 516 (describe above with reference to example implementation of FIG. 4), a header length field, and one or more logical channel ID (LCID) subheaders and MAC control elements (MAC CE1, MAC CE2, . . . ). MAC control elements may be used to communicate various control information, such as a buffer status report (BSR), power related information, and/or other control information.

In one option, as noted above with respect to FIG. 4, a MAC_PDU_type field 516 may be provided within the MAC header 512 that specifies the MAC PDU 510 to be a duplicate (or not) of the re-transmitted PDU during a same TTI. According to one illustrative example implementation, if the MAC PDU 510 is designated by MAC_PDU_type field 516 as a duplicate, then the UE 132 may typically include in MAC PDU 510 the same contents (including same data/MAC payload) as the retransmitted MAC PDU (during same TTI) but will just change the MAC_PDU_type field 516 in MAC PDU 510 from non-duplicate to duplicate. Thus, in an illustrative example implementation, no further MAC operations are required to duplicate the MAC PDU, with the exception of changing a value of the MAC_PDU_type field from non-duplicate to duplicate.

In another example implementation, the network or AP 134 may schedule a different modulation a coding scheme (MCS) for the duplicate PDU/TB, as compared to the retransmitted TB/PDU. In this case the UE will not duplicate the MAC PDU but will generate a new MAC PDU (because a new coding scheme is used for the duplicate PDU) to correspond to an indicated TB size and duplicates the MAC SDUs (or MAC payload) from the re-transmitted TB. Thus, for example, a new coding scheme may be used for the duplicate PDU to accommodate a different MAC PDU size or a different TB size.

In one option the network or AP 134 schedules a higher MCS for the duplicate PDU/TB to dimension possible MAC control elements (CEs) that could be transmitted in the duplicate TB. For example, if the MCS is higher, more bits may be sent in a TB. Thus, a new MAC PDU may be constructed or generated which includes additional data, e.g., the MAC CEs, in an illustrative example. In duplicate data in this example, the entire TB is not a duplicate, but rather, the new MAC PDU contains the duplicated MAC SDUs plus additional MAC CEs, for example. In an example implementation, this also require that new encoding should be applied to the duplicate PDU.

In another option, each of the MAC SDUs and each of the MAC control elements (CEs) has a priority. If, for example based on a different MCS being used for the duplicate PDU/TB (as compared to the MCS of the retransmitted PDU/TB during same TTI), the entire MAC payload of the retransmitted PDU/TB will not fit in the MAC payload 514 of the duplicate PDU/TB, then the MAC SDUs and/or control elements (CEs) of the retransmitted PDU may be allocated or copied into the payload of the duplicate MAC PDU (for transmission) according to priority. In other words, if there is not sufficient space in the payload of the duplicate PDU/TB for all MAC CEs and MAC SDUs of the retransmitted PDU/TB, then the highest priority MAC SDUs and/or MAC CEs of the retransmitted PDU may be allocated to the duplicate PDU for transmission. In some cases, lower or lowest priority CEs and/or SDUs of the retransmitted PDU/TB may be omitted from the duplicate PDU/TB. In such a case, data combining may be performed by AP 134 with respect to those (common) data portions (SDUs and/or CEs) received via both the retransmitted PDU and the duplicate PDU, for example (or which are common between one of the retransmitted PDU or duplicate PDU and an original PDU). For example, UE 132 may duplicate as many MAC SDUs from the re-transmitted TB as possible such that the MAC CE(s) will also fit to the generated MAC PDU. In one example option, the MAC SDUs may be duplicated according to the associated logical channel priorities in decreasing priority order.

In another example implementation, if the UE 132 did not report an empty BSR previously, then the UE 132 may autonomously (e.g., without being requested by the AP 134) conduct the duplication of MAC payload (or portion thereof, e.g., MAC CEs and/or MAC SDUs) from retransmitted PDU/TB. In one option, if the MCS for the duplicate PDU/TB is the same as the MCS for retransmitted PDU/TB, the UE 132 may duplicate the retransmitted TB. In one option, the UE may associate the duplicate PDU/TB with a different RV (redundancy version) than the re-transmitted PDU/TB. In one option, the UE may have a specified order for the RV usage for the duplicate PDU/TB that may or may not be derived from the RV of the retransmitted PDU/TB. In one option, the UE uses the RV in the scheduling grant as the RV for the duplicate PDU/TB.

In one option, if the MCS of the duplicate PDU/TB is different (higher/lower) than the MCS of the retransmitted PDU/TB, the UE may, for example: A) If the duplicate PDU/TB size is bigger than or equal to size of the retransmitted TB+BSR report and its MAC subheader: Duplicate the MAC SDUs from the re-transmitted PDU/TB and generate the duplicate MAC PDU with empty BSR. B) Else (duplicate PDU/TB size is not as big as size of retransmitted TB+BSR report and its MAC subheader): Duplicate as many MAC SDUs from the retransmitted PDU/TB as possible such that empty BSR will fit to the generated MAC PDU. Thus, in this case, empty BSR (indicating no new data to transfer) is treated as a high priority control element, to be sent in duplicate PDU/TB. In one option the MAC SDUs are duplicated according to the associated logical channel priorities in decreasing priority order.

In one embodiment, if the MCS of duplicate PDU/TB is different than MCS of retransmitted PDU/TB, the UE will indicate to AP 134/network about the MAC SDU duplications (e.g., indicating which MAC SDUs are included in duplicate PDU/TB) via a new MAC CE provided in duplicate PDU/TB. In one option, the AP 134/network can derive from the MAC CE that the UE's uplink data buffer is empty (no new data for transmission). In one embodiment the AP 134/network can enable the duplication scheme to be used by configuring the user device via dedicated signalling, like RRC (radio resource control) signalling or MAC signalling.

According to various example implementations, the above defined example implementations can be generalized to cases or wireless systems that can transmit more than 2 TBs per TTI, e.g., when one PDU/TB needs to be retransmitted. One or more of the other TBs during the TTI2 can be used for duplication to ensure best possible likelihood for the retransmitted TB to be decoded by receiver/AP 134.

For other cases, the following additional example implementations or features may also be provided: When the amount of PDUs/TBs to be retransmitted correspond to TBs that can be used for duplication, the AP 134/network can schedule the duplicate TBs MCSs such that each retransmitted TB is duplicated once in another duplicated TB. If the amount of retransmitted PDUs/TBs is higher than TBs that can be used for duplication, the AP 134/network may indicate which TB the UE should use to send the duplicate PDU and adapt/adjust the MCS for the duplicate PDU/TB. In one option the UE will duplicate the highest priority MAC SDUs from one or multiple retransmitted PDUs/TBs up to the amount that fits to the duplicated TBs. Thus, one or more MAC SDUs of each of multiple retransmitted PDUs/TBs may be allocated for one or more duplicate PDUs/TBs (or a plurality of duplicate PDUs/TBs) up to the amount of MAC SDUs that fit in the one or more duplicate PDUs/TBs.

Therefore, one or more of the example implementations may take advantage of the unused TBs that have to be scheduled along with the retransmitted TBs, e.g., when there is no additional data to be transmitted in the unused TBs.

In one additional example, if, during the retransmission procedure, described herein, the UE has new data available in the buffer, additional procedures may be triggered. For example, it could be left up to the UE whether to send the duplication of PDU (or duplicate payload/duplicate SDUs) or new data via TB4. In one option, even though the UE would send the duplicated data via MAC duplicate PDU (MAC PDU with MAC_PDU_type set to duplicate), it could indicate a BSR report indicating that more data has become available in its buffer. In other words, in an example implementation, the UE may send duplicate data/duplicate payload/duplicate SDUs via a duplicate PDU (e.g., MAC PDU with MAC_PDU_type=duplicate), even though the UE may have new data in its data buffer awaiting transmission.

According to an example implementation, one or more features of the example implementation described with reference to FIG. 3 may be combined with one or more features of the example implementations described with reference to FIG. 4 and/or FIG. 5. According to an example implementation, one or more features of the example implementation described with reference to FIG. 4 may be combined with one or more features of the example implementations described with reference to FIG. 3 and/or FIG. 5. And, according to an example implementation, one or more features of the example implementation described with reference to FIG. 5 may be combined with one or more features of the example implementations described with reference to FIG. 3 and/or FIG. 4.

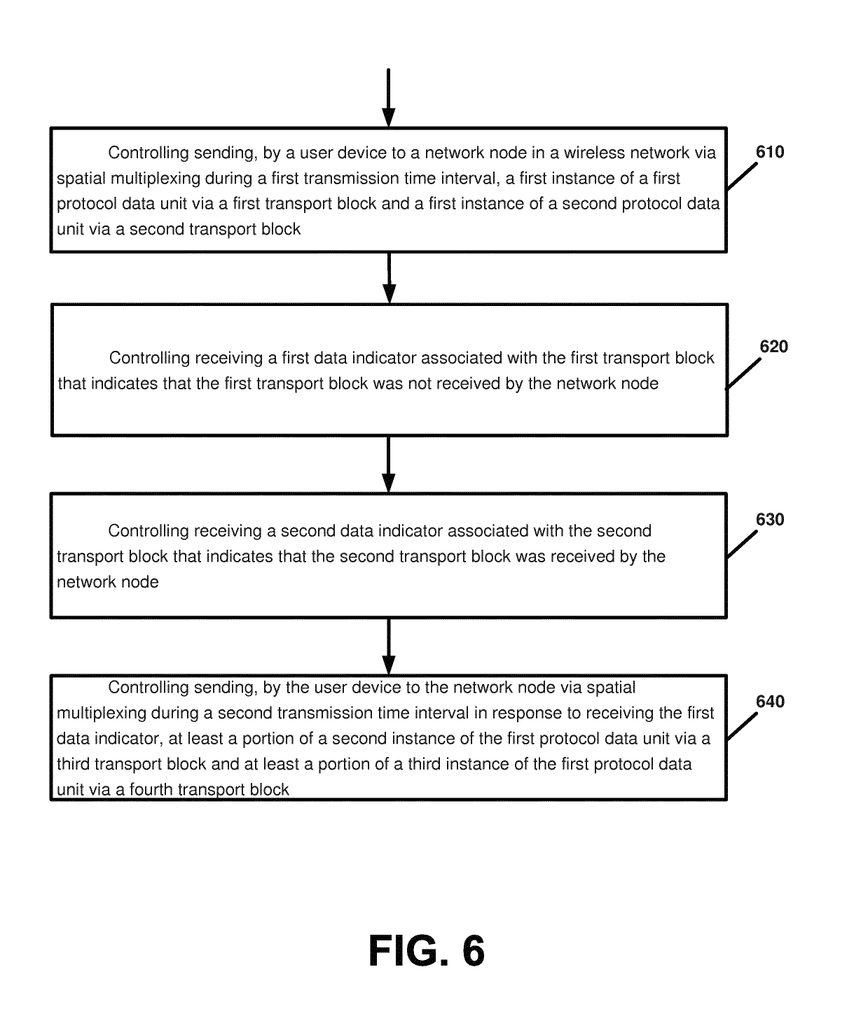

FIG. 6 is a flow chart illustrating operation of a user device according to an example implementation. Operation 610 includes controlling sending, by a user device to a network node in a wireless network via spatial multiplexing during a first transmission time interval, a first instance of a first protocol data unit via a first transport block and a first instance of a second protocol data unit via a second transport block. Operation 620 includes controlling receiving a first data indicator associated with the first transport block that indicates that the first transport block was not received by the network node. Operation 630 includes controlling receiving a second data indicator associated with the second transport block that indicates that the second transport block was received by the network node. And, operation 640 includes controlling sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

According to an example implementation of the method of FIG. 6, the controlling sending, by the user device to the network node during the second transmission time interval in response to receiving the first data indicator, the second instance of the first protocol data unit via the third transport block may include controlling sending, by the user device to the network node during the second transmission time interval in response to receiving the first data indicator, a first redundancy version of the first protocol data unit via the third transport block; and the controlling sending, by the user device to the network node during the second transmission time interval in response to receiving the first data indicator, the third instance of the first protocol data unit via the fourth transport block may include controlling sending, by the user device to the network node during the second transmission time interval in response to receiving the first data indicator, a second redundancy version of the first protocol data unit via the fourth transport block, wherein the first redundancy version and the second redundancy version are different.

According to an example implementation of the method of FIG. 6, the third transport block is a retransmission of the first transport block, as a redundancy version of the first protocol data unit, wherein the redundancy version is indicated by the network node; and the fourth transport block is a duplicate of the first transport block.

According to an example implementation of the method of FIG. 6, the method may further include controlling sending, by the user device to the network node, a buffer status report indicating that the user device has no data for transmission.

According to an example implementation of the method of FIG. 6, wherein at least one of the following is used to specify the first and second redundancy versions: selecting, by the user device, the first and second redundancy versions; and controlling receiving, by the user device from the network node, a control signaling indicating the first and second redundancy versions.

According to an example implementation of the method of FIG. 6, wherein a common modulation and coding scheme is used for controlling sending both the at least a portion of the second instance of the first protocol data unit via the third transport block and the at least the portion of the third instance of the first protocol data unit via the fourth transport block.

According to an example implementation of the method of FIG. 6, wherein a first modulation and coding scheme is used for controlling sending the at least a portion of the second instance of the first protocol data unit via the third transport block, and a second modulation and coding scheme, different from the first modulation and coding scheme, is used for controlling sending the at least a portion of the third instance of the first protocol data unit via the fourth transport block.

According to an example implementation of the method of FIG. 6, wherein: the at least a portion of the second instance of the first protocol data unit includes a protocol data unit type field that indicates that the second instance of the first protocol data unit is an initial or non-duplicate protocol data unit; and, the at least a portion of the third instance of the first protocol data unit includes a protocol data unit type field that indicates that a payload of the third instance of the first protocol data unit is a duplicate of the payload of the second instance of the first protocol data unit.

According to an example implementation of the method of FIG. 6, the method further including controlling receiving, by the user device from the network node, hybrid ARQ feedback for only one of the second instance and the third instance of the first protocol data unit, but not for both of the second and third instances of the first protocol data units.

According to an example implementation of the method of FIG. 6, wherein the first protocol data unit includes a plurality of service data units, each service data unit having a priority, the method further including: allocating one or more of the service data units of the first protocol data unit to the at least a portion of a third instance of the first protocol data unit based on priority of the service data units.

According to an example implementation of the method of FIG. 6, wherein the first protocol data unit includes a plurality of service data units and a plurality of control elements, each service data unit and control element having a priority, the method further including: allocating at least one of the service data units and control elements of the first protocol data unit to the at least a portion of a third instance of the first protocol data unit based on priority of the service data units and the priority of the control elements.

According to an example implementation of the method of FIG. 6, an apparatus may be provided that includes means for carrying out the method according to any one the method operations described herein.

According to an example implementation of the method of FIG. 6, a computer program product for a computer includes software code portions for performing any method operations described herein when the product is run on the computer.

An apparatus may include at least one processor and at least one memory including computer instructions, when executed by the at least one processor, cause the apparatus to: control sending, by a user device to a network node in a wireless network via spatial multiplexing during a first transmission time interval, a first instance of a first protocol data unit via a first transport block and a first instance of a second protocol data unit via a second transport block; control receiving a first data indicator associated with the first transport block that indicates that the first transport block was not received by the network node; control receiving a second data indicator associated with the second transport block that indicates that the second transport block was received by the network node; and control sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

According to an example implementation of the apparatus, wherein instructions causing the apparatus to control sending, by the user device to the network node during the second transmission time interval in response to receiving the first data indicator, the second instance of the first protocol data unit via the third transport block comprise instructions causing the apparatus to control sending, by the user device to the network node during the second transmission time interval in response to receiving the first data indicator, a first redundancy version of the first protocol data unit via the third transport block; and wherein instructions causing the apparatus to control sending, by the user device to the network node during the second transmission time interval in response to receiving the first data indicator, the third instance of the first protocol data unit via the fourth transport block include instructions causing the apparatus to control sending, by the user device to the network node during the second transmission time interval in response to receiving the first data indicator, a second redundancy version of the first protocol data unit via the fourth transport block, wherein the first redundancy version and the second redundancy version are different.

According to an example implementation of the apparatus,

wherein: the third transport block is a retransmission of the first transport block, as a redundancy version of the first protocol data unit, wherein the redundancy version is indicated by the network node; and the fourth transport block is a duplicate of the first transport block.

According to an example implementation of the apparatus, further including instructions causing the apparatus to: control sending, by the user device to the network node, a buffer status report indicating that the user device has no data for transmission.

According to an example implementation of the apparatus, wherein at least one of the following is used to specify the first and second redundancy versions: causing the apparatus to select, by the user device, the first and second redundancy versions; causing the apparatus to receive, by the user device from the network node, a control signaling indicating the first and second redundancy versions.

According to an example implementation of the apparatus, wherein a common modulation and coding scheme is used for controlling sending both the at least a portion of the second instance of the first protocol data unit via the third transport block and the at least the portion of the third instance of the first protocol data unit via the fourth transport block.

According to an example implementation of the apparatus, wherein a first modulation and coding scheme is used for controlling sending the at least a portion of the second instance of the first protocol data unit via the third transport block, and a second modulation and coding scheme, different from the first modulation and coding scheme, is used for controlling sending the at least a portion of the third instance of the first protocol data unit via the fourth transport block.

According to an example implementation of the apparatus, wherein: the at least a portion of the second instance of the first protocol data unit includes a protocol data unit type field that indicates that the second instance of the first protocol data unit is an initial or non-duplicate protocol data unit; the at least a portion of the third instance of the first protocol data unit includes a protocol data unit type field that indicates that a payload of the third instance of the first protocol data unit is a duplicate of the payload of the second instance of the first protocol data unit.

According to an example implementation of the apparatus, and further including instructions that cause the apparatus to: control receiving, by the user device from the network node, hybrid ARQ feedback for only one of the second instance and the third instance of the first protocol data unit, but not for both of the second and third instances of the first protocol data units.

According to an example implementation of the apparatus, wherein the first protocol data unit includes a plurality of service data units, each service data unit having a priority, the apparatus further comprising instructions that cause the apparatus to: allocate one or more of the service data units of the first protocol data unit to the at least a portion of a third instance of the first protocol data unit based on priority of the service data units.

According to an example implementation of the apparatus, wherein the first protocol data unit includes a plurality of service data units and a plurality of control elements, each service data unit and control element having a priority, the apparatus further including instructions that cause the apparatus to: allocate at least one of the service data units and control elements of the first protocol data unit to the at least a portion of a third instance of the first protocol data unit based on priority of the service data units and the priority of the control elements.

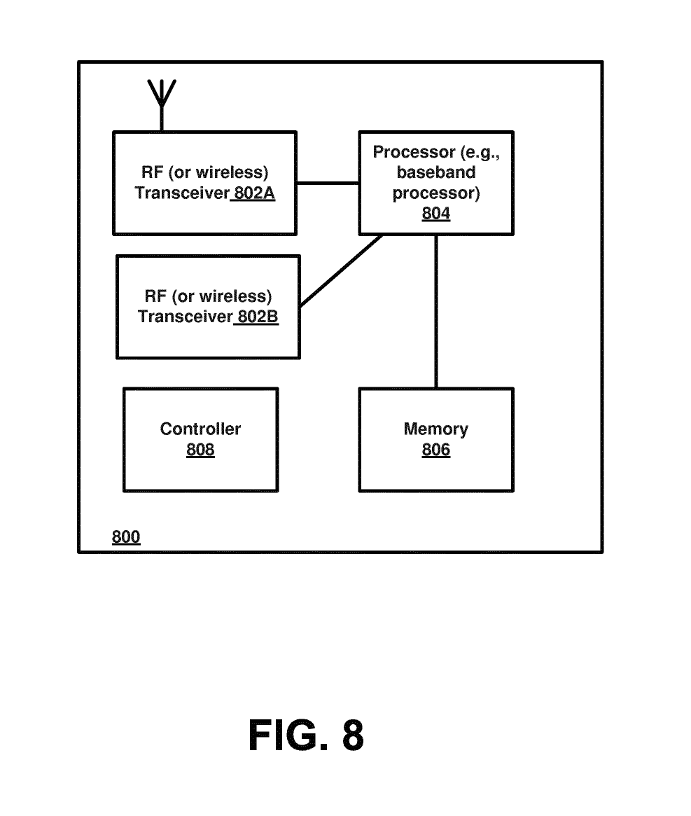

According to an example implementation, an apparatus includes means (e.g., 802A/802B and/or 804, FIG. 8) for controlling sending, by a user device to a network node in a wireless network via spatial multiplexing during a first transmission time interval, a first instance of a first protocol data unit via a first transport block and a first instance of a second protocol data unit via a second transport block; means (e.g., 802A/802B and/or 804, FIG. 8) for controlling receiving a first data indicator associated with the first transport block that indicates that the first transport block was not received by the network node; means (e.g., 802A/802B and/or 804, FIG. 8) for controlling receiving a second data indicator associated with the second transport block that indicates that the second transport block was received by the network node; and means (e.g., 802A/802B and/or 804, FIG. 8) for controlling sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

According to an example implementation of the apparatus, the means for controlling sending, by the user device to the network node during the second transmission time interval in response to receiving the first data indicator, the second instance of the first protocol data unit via the third transport block may include means (e.g., 802A/802B and/or 804, FIG. 8) for controlling sending, by the user device to the network node during the second transmission time interval in response to receiving the first data indicator, a first redundancy version of the first protocol data unit via the third transport block; and the means for controlling sending, by the user device to the network node during the second transmission time interval in response to receiving the first data indicator, the third instance of the first protocol data unit via the fourth transport block may include means (e.g., 802A/802B and/or 804, FIG. 8) for controlling sending, by the user device to the network node during the second transmission time interval in response to receiving the first data indicator, a second redundancy version of the first protocol data unit via the fourth transport block, wherein the first redundancy version and the second redundancy version are different.

According to an example implementation of the method of the apparatus, the third transport block is a retransmission of the first transport block, as a redundancy version of the first protocol data unit, wherein the redundancy version is indicated by the network node; and the fourth transport block is a duplicate of the first transport block.

According to an example implementation of the apparatus, the apparatus may further include means (e.g., 802A/802B and/or 804, FIG. 8) for controlling sending, by the user device to the network node, a buffer status report indicating that the user device has no data for transmission.

According to an example implementation of the apparatus, wherein at least one of the following is used to specify the first and second redundancy versions: selecting, by the user device, the first and second redundancy versions; and controlling receiving, by the user device from the network node, a control signaling indicating the first and second redundancy versions.

According to an example implementation of the apparatus, wherein a common modulation and coding scheme is used for controlling sending both the at least a portion of the second instance of the first protocol data unit via the third transport block and the at least the portion of the third instance of the first protocol data unit via the fourth transport block.

According to an example implementation of the apparatus, wherein a first modulation and coding scheme is used for controlling sending the at least a portion of the second instance of the first protocol data unit via the third transport block, and a second modulation and coding scheme, different from the first modulation and coding scheme, is used for controlling sending the at least a portion of the third instance of the first protocol data unit via the fourth transport block.

According to an example implementation of the apparatus, wherein: the at least a portion of the second instance of the first protocol data unit includes a protocol data unit type field that indicates that the second instance of the first protocol data unit is an initial or non-duplicate protocol data unit; and, the at least a portion of the third instance of the first protocol data unit includes a protocol data unit type field that indicates that a payload of the third instance of the first protocol data unit is a duplicate of the payload of the second instance of the first protocol data unit.

According to an example implementation of the apparatus, the apparatus further including means (e.g., 802A/802B and/or 804, FIG. 8) for controlling receiving, by the user device from the network node, hybrid ARQ feedback for only one of the second instance and the third instance of the first protocol data unit, but not for both of the second and third instances of the first protocol data units.

According to an example implementation of the apparatus, wherein the first protocol data unit includes a plurality of service data units, each service data unit having a priority, the apparatus further including: means (e.g., 802A/802B and/or 804, FIG. 8) for allocating one or more of the service data units of the first protocol data unit to the at least a portion of a third instance of the first protocol data unit based on priority of the service data units.

According to an example implementation of the apparatus, wherein the first protocol data unit includes a plurality of service data units and a plurality of control elements, each service data unit and control element having a priority, the apparatus further including: means (e.g., 802A/802B and/or 804, FIG. 8) for allocating at least one of the service data units and control elements of the first protocol data unit to the at least a portion of a third instance of the first protocol data unit based on priority of the service data units and the priority of the control elements.

According to an example implementation, a computer program product includes a computer-readable storage medium and storing executable code that, when executed by at least one data processing apparatus, is configured to cause the at least one data processing apparatus to perform a method including: control sending, by a user device to a network node in a wireless network via spatial multiplexing during a first transmission time interval, a first instance of a first protocol data unit via a first transport block and a first instance of a second protocol data unit via a second transport block; control receiving a first data indicator associated with the first transport block that indicates that the first transport block was not received by the network node; control receiving a second data indicator associated with the second transport block that indicates that the second transport block was received by the network node; and control sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

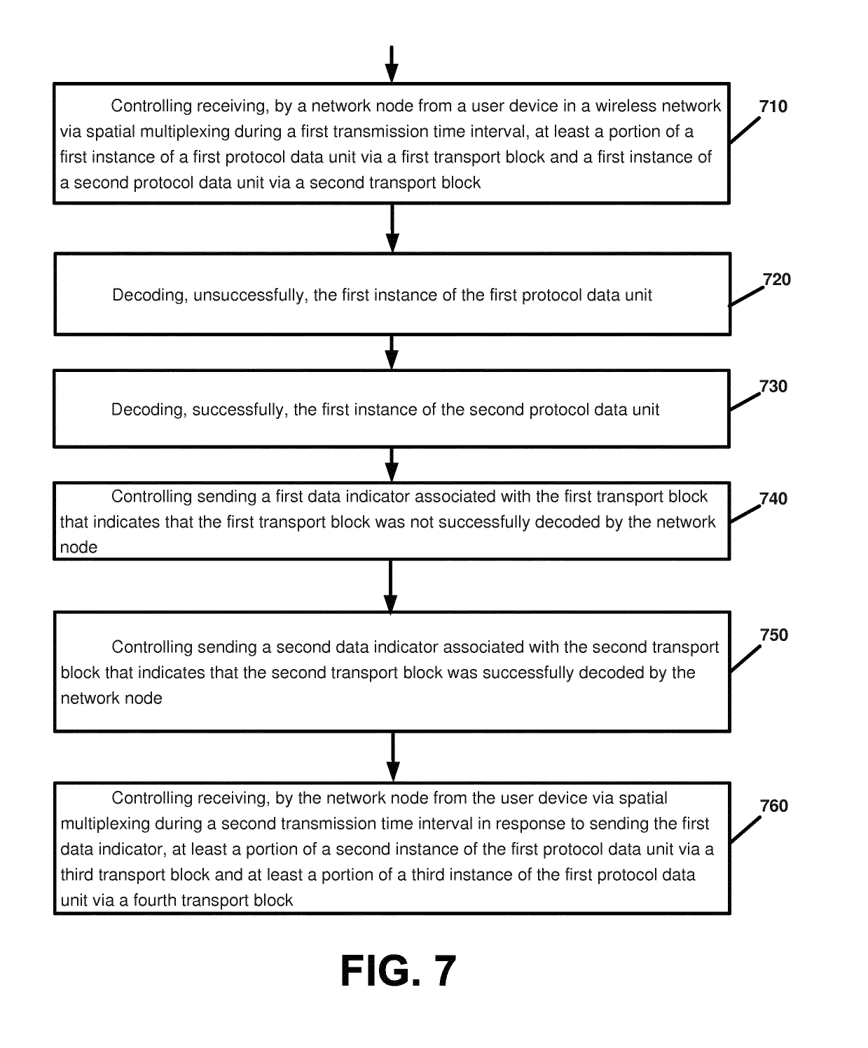

FIG. 7 is a flow chart illustrating operation of a network node according to an example implementation. Operation 710 includes controlling receiving, by a network node from a user device in a wireless network via spatial multiplexing during a first transmission time interval, at least a portion of a first instance of a first protocol data unit via a first transport block and a first instance of a second protocol data unit via a second transport block. Operation 720 includes decoding, unsuccessfully, the first instance of the first protocol data unit. Operation 730 includes decoding, successfully, the first instance of the second protocol data unit. Operation 740 includes controlling sending a first data indicator associated with the first transport block that indicates that the first transport block was not successfully decoded by the network node. Operation 750 includes controlling sending a second data indicator associated with the second transport block that indicates that the second transport block was successfully decoded by the network node. Operation 760 includes controlling receiving, by the network node from the user device to the network node via spatial multiplexing during a second transmission time interval in response to sending the first data indicator, at least a portion of a second instance of the first protocol data unit via a third transport block and at least a portion of a third instance of the first protocol data unit via a fourth transport block.

According to an example implementation of the method of FIG. 7, the at least a portion of the second instance of the first protocol data unit may include a first redundancy version of the first protocol data unit; and the at least a portion of the third instance of the first protocol data unit may include a second redundancy version of the first protocol data unit.

According to an example implementation of the method of FIG. 7, the at least a portion of the second instance of the first protocol data unit includes a protocol data unit type field that indicates that the second instance of the first protocol data unit is an initial or non-duplicate protocol data unit; and the at least a portion of the third instance of the first protocol data unit includes a protocol data unit type field that indicates that a payload of the third instance of the first protocol data unit is a duplicate of the payload of the second instance of the first protocol data unit.

According to an example implementation, an apparatus may include means (e.g., 802A/802B and/or 804, FIG. 8) for controlling receiving, by a network node from a user device in a wireless network via spatial multiplexing during a first transmission time interval, at least a portion of a first instance of a first protocol data unit via a first transport block and a first instance of a second protocol data unit via a second transport block; means (e.g., 802A/802B and/or 804, FIG. 8) for decoding, unsuccessfully, the first instance of the first protocol data unit; means (e.g., 802A/802B and/or 804, FIG. 8) for decoding, successfully, the first instance of the second protocol data unit; means (e.g., 802A/802B and/or 804, FIG. 8) for controlling sending a first data indicator associated with the first transport block that indicates that the first transport block was not successfully decoded by the network node; means (e.g., 802A/802B and/or 804, FIG. 8) for controlling sending a second data indicator associated with the second transport block that indicates that the second transport block was successfully decoded by the network node; and means (e.g., 802A/802B and/or 804, FIG. 8) for controlling receiving, by the network node from the user device to the network node via spatial multiplexing during a second transmission time interval in response to sending the first data indicator, at least a portion of a second instance of the first protocol data unit via a third transport block and at least a portion of a third instance of the first protocol data unit via a fourth transport block.

An apparatus comprising at least one processor and at least one memory including computer instructions, when executed by the at least one processor, cause the apparatus to: control receiving, by a network node from a user device in a wireless network via spatial multiplexing during a first transmission time interval, at least a portion of a first instance of a first protocol data unit via a first transport block and a first instance of a second protocol data unit via a second transport block; decode, unsuccessfully, the first instance of the first protocol data unit; decode, successfully, the first instance of the second protocol data unit; control sending a first data indicator associated with the first transport block that indicates that the first transport block was not successfully decoded by the network node; control sending a second data indicator associated with the second transport block that indicates that the second transport block was successfully decoded by the network node; and control receiving, by the network node from the user device to the network node via spatial multiplexing during a second transmission time interval in response to sending the first data indicator, at least a portion of a second instance of the first protocol data unit via a third transport block and at least a portion of a third instance of the first protocol data unit via a fourth transport block.

According to an example implementation of the apparatus, the at least a portion of the second instance of the first protocol data unit includes a first redundancy version of the first protocol data unit; and the at least a portion of the third instance of the first protocol data unit includes a second redundancy version of the first protocol data unit.

According to an example implementation of the apparatus, the at least a portion of the second instance of the first protocol data unit includes a protocol data unit type field that indicates that the second instance of the first protocol data unit is an initial or non-duplicate protocol data unit; and the at least a portion of the third instance of the first protocol data unit includes a protocol data unit type field that indicates that a payload of the third instance of the first protocol data unit is a duplicate of the payload of the second instance of the first protocol data unit.

FIG. 8 is a block diagram of a wireless station (e.g., AP or user device) 800 according to an example implementation. The wireless station 800 may include, for example, one or two RF (radio frequency) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
controlling sending, by a user device to a network node in a wireless network via spatial multiplexing during a first transmission time interval, a first instance of a first protocol data unit via a first transport block and a first instance of a second protocol data unit via a second transport block;
controlling receiving a first data indicator associated with the first transport block that indicates that the first transport block was not received by the network node;
controlling receiving a second data indicator associated with the second transport block that indicates that the second transport block was received by the network node; and
controlling sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

2-13. (canceled)

14. An apparatus comprising at least one processor and at least one memory including computer instructions, when executed by the at least one processor, cause the apparatus to:
control sending, by a user device to a network node in a wireless network via spatial multiplexing during a first transmission time interval, a first instance of a first protocol data unit via a first transport block and a first instance of a second protocol data unit via a second transport block;
control receiving a first data indicator associated with the first transport block that indicates that the first transport block was not received by the network node;
control receiving a second data indicator associated with the second transport block that indicates that the second transport block was received by the network node; and
control sending, by the user device to the network node via spatial multiplexing during a second transmission time interval in response to receiving the first data indicator, at least a portion of a second instance of the first protocol data unit via a third transport block and at least a portion of a third instance of the first protocol data unit via a fourth transport block.

15. The apparatus of claim 14 wherein:
wherein instructions causing the apparatus to control sending, by the user device to the network node during the second transmission time interval in response to receiving the first data indicator, the second instance of the first protocol data unit via the third transport block comprise instructions causing the apparatus to control sending, by the user device to the network node during the second transmission time interval in response to receiving the first data indicator, a first redundancy version of the first protocol data unit via the third transport block; and
wherein instructions causing the apparatus to control sending, by the user device to the network node during the second transmission time interval in response to receiving the first data indicator, the third instance of the first protocol data unit via the fourth transport block comprise instructions causing the apparatus to control sending, by the user device to the network node during the second transmission time interval in response to receiving the first data indicator, a second redundancy version of the first protocol data unit via the fourth transport block, wherein the first redundancy version and the second redundancy version are different.

16. The apparatus of claim 14 wherein:
the third transport block is a retransmission of the first transport block, as a redundancy version of the first protocol data unit, wherein the redundancy version is indicated by the network node; and
the fourth transport block is a duplicate of the first transport block.

17. The apparatus of claim 14, further comprising instructions causing the apparatus to:
control sending, by the user device to the network node, a buffer status report indicating that the user device has no data for transmission.

18. The apparatus of any of claim 14 wherein at least one of the following is used to specify the first and second redundancy versions:
causing the apparatus to select, by the user device, the first and second redundancy versions;
causing the apparatus to receive, by the user device from the network node, a control signaling indicating the first and second redundancy versions.

19. The apparatus of claim 14 wherein a common modulation and coding scheme is used for controlling sending both the at least a portion of the second instance of the first protocol data unit via the third transport block and the at least the portion of the third instance of the first protocol data unit via the fourth transport block.

20. The apparatus of claim 14 wherein a first modulation and coding scheme is used for controlling sending the at least a portion of the second instance of the first protocol data unit via the third transport block, and a second modulation and coding scheme, different from the first modulation and coding scheme, is used for controlling sending the at least a portion of the third instance of the first protocol data unit via the fourth transport block.

21. The apparatus of claim 14 wherein:
the at least a portion of the second instance of the first protocol data unit includes a protocol data unit type field that indicates that the second instance of the first protocol data unit is an initial or non-duplicate protocol data unit;
the at least a portion of the third instance of the first protocol data unit includes a protocol data unit type field that indicates that a payload of the third instance of the first protocol data unit is a duplicate of the payload of the second instance of the first protocol data unit.

22. The apparatus of claim 14 and further comprising instructions that cause the apparatus to:
control receiving, by the user device from the network node, hybrid ARQ feedback for only one of the second instance and the third instance of the first protocol data unit, but not for both of the second and third instances of the first protocol data units.

23. The apparatus of claim 14 wherein the first protocol data unit includes a plurality of service data units, each service data unit having a priority, the apparatus further comprising instructions that cause the apparatus to:
allocate one or more of the service data units of the first protocol data unit to the at least a portion of a third instance of the first protocol data unit based on priority of the service data units.

24. The apparatus of claim 14 wherein the first protocol data unit includes a plurality of service data units and a plurality of control elements, each service data unit and control element having a priority, the apparatus further comprising instructions that cause the apparatus to:
allocate at least one of the service data units and control elements of the first protocol data unit to the at least a portion of a third instance of the first protocol data unit based on priority of the service data units and the priority of the control elements.

25-26. (canceled)

27. A method comprising:
controlling receiving, by a network node from a user device in a wireless network via spatial multiplexing during a first transmission time interval, at least a portion of a first instance of a first protocol data unit via a first transport block and a first instance of a second protocol data unit via a second transport block;
decoding, unsuccessfully, the first instance of the first protocol data unit;
decoding, successfully, the first instance of the second protocol data unit;
controlling sending a first data indicator associated with the first transport block that indicates that the first transport block was not successfully decoded by the network node;
controlling sending a second data indicator associated with the second transport block that indicates that the second transport block was successfully decoded by the network node; and
controlling receiving, by the network node from the user device to the network node via spatial multiplexing during a second transmission time interval in response to sending the first data indicator, at least a portion of a second instance of the first protocol data unit via a third transport block and at least a portion of a third instance of the first protocol data unit via a fourth transport block.

28-31. (canceled)

32. An apparatus comprising at least one processor and at least one memory including computer instructions, when executed by the at least one processor, cause the apparatus to:
control receiving, by a network node from a user device in a wireless network via spatial multiplexing during a first transmission time interval, at least a portion of a first instance of a first protocol data unit via a first transport block and a first instance of a second protocol data unit via a second transport block;
decode, unsuccessfully, the first instance of the first protocol data unit;
decode, successfully, the first instance of the second protocol data unit;
control sending a first data indicator associated with the first transport block that indicates that the first transport block was not successfully decoded by the network node;
control sending a second data indicator associated with the second transport block that indicates that the second transport block was successfully decoded by the network node; and
control receiving, by the network node from the user device to the network node via spatial multiplexing during a second transmission time interval in response to sending the first data indicator, at least a portion of a second instance of the first protocol data unit via a third transport block and at least a portion of a third instance of the first protocol data unit via a fourth transport block.

33. The apparatus of claim 32, wherein:
the at least a portion of the second instance of the first protocol data unit comprises a first redundancy version of the first protocol data unit; and
the at least a portion of the third instance of the first protocol data unit comprises a second redundancy version of the first protocol data unit.

34. The apparatus of claim 32, wherein:
the at least a portion of the second instance of the first protocol data unit includes a protocol data unit type field that indicates that the second instance of the first protocol data unit is an initial or non-duplicate protocol data unit; and
the at least a portion of the third instance of the first protocol data unit includes a protocol data unit type field that indicates that a payload of the third instance of the first protocol data unit is a duplicate of the payload of the second instance of the first protocol data unit.

35-36. (canceled)
